(19) United States
(12) Patent Application Publication
(10) Pub. No.: US 2015/0086035 A1
(43) Pub. Date: Mar. 26, 2015

(54) SOUND CONTROL SYSTEM AND METHOD FOR VEHICLE

(71) Applicant: Hyundai Motor Company, Seoul (KR)

(72) Inventor: Yong Jin Shin, Hwaseong (KR)

(73) Assignee: Hyundai Motor Company, Seoul (KR)

(21) Appl. No.: 14/141,675

(22) Filed: Dec. 27, 2013

(30) Foreign Application Priority Data
Sep. 25, 2013 (KR) 10-2013-0113594

(51) Int. Cl. H04R 1/02; B60R 11/02

(52) U.S. Cl. CPC H04R 1/02; B60R 11/0217; H04R 2499/13
USPC 381/86

(57) ABSTRACT

A sound control system and method for a vehicle are provided and a sound output of a speaker is automatically adjusted based on a position in which a passenger enters in a seat within the vehicle to provide an optimum sound state. The system includes a passenger detecting unit that is installed at each seat of the vehicle and is configured to detect a passenger entering a seat and a controller that is configured to detect a passenger riding position within the vehicle from a passenger detecting signal output by the passenger detecting unit. In addition, the controller is configured to adjust sound through each speaker within the vehicle based on the passenger riding position.

### CROSS-REFERENCE TO RELATED PATENT APPLICATION

This application claims the benefit of Korean Patent Application No. 10-2013-0113594, filed on Sep. 25, 2013 in the Korean Intellectual Property Office, the disclosure of which is incorporated herein in its entirety by reference.

### BACKGROUND

1. Field of the Invention

The present invention relates to a sound control system and method for a vehicle, and more particularly, to a sound control system and method for a vehicle, wherein a sound output from a speaker is automatically adjusted according to a position in which a passenger enters the vehicle, including a driver (depending on whether a passenger enters) to provide optimum sound.

2. Description of the Related Art

Nowadays development of multimedia technology induces evolution of a comfortable vehicle or a convenience vehicle that provide information to a driver, and this evolution of vehicles is connected to the development of information transmission technology that targets a driver. In addition, as the complexity of a vehicle increases and running and usage patterns remain diverse, more information is required from an inner side/outer side of the vehicle while driving, and the shape of information that can be provided to the driver or a passenger becomes more diverse, such as characters, sound, images, or graphics. An audio, video, and navigation (AVN) system mounted on the vehicle interlocks with a driver's information system (DIS), a navigation system, and a telematics system and provides various information and multimedia contents that are requested by the driver.

Recently, in addition to the usage of the system mounted on the vehicle, the usage of contents of music or movies by connecting a smartphone, a tablet computer, an MP3 player, or a universal serial bus (USB) memory to the vehicle is increasing. Accordingly, the usage of a speaker that outputs sound within the vehicle is configured to provide sound information and multimedia contents to the driver and the passenger of the vehicle. A main configuration for reproducing a sound source in an audio system or an AVN system consists of a sound source input terminal, a digital signal processor (DSP), an amplifier, and a speaker. In particular, the sound source input terminal is an input terminal to which a sound source is input from an exterior, and the DSP performs signal processing on the sound source input through the sound source input terminal, and the amplifier amplifies the signal-processed sound source and outputs the amplified sound source to the speaker.

Generally, the performance of the audio system that provides improved sound including the performance of the speaker is one of main purchasing factors of the vehicle since, in the related art, vehicle stability is a significant criterion for selecting a vehicle. However, recently, convenience of the vehicle to be provided to the driver or the passenger in addition to vehicle stability is also a significant criterion for selecting the vehicle.

Generally, sound output characteristics through the speaker and a sound image position in the audio system or the AVN system of the vehicle are set based on spatial characteristics of the interior when the vehicle is developed, and in particular, optimum sound output characteristics and a sound image position are set based on a position of a driver's seat. In other words, an indoor sound image position according to the vehicle is tuned to be optimized for the driver, and a tuning value is applied by giving more weight to the driver's seat than a passenger's seat (for example, driver's seat:passenger's seat=7:3). FIG. 1 illustrates an example of sound tuning within a vehicle. As illustrated in FIG. 1, in the related art, a sound image position of sound output from speakers 30 of the vehicle is set to be optimized for the driver based on a position of a driver's seat (e.g., a front left seat of FIG. 1), and correction of this tuning value cannot be made after the vehicle is manufactured.

However, utilization of the vehicle is increasing for a leisure purpose for a family in addition to a purpose only for the driver, for a commuting purpose. As described above, a tuning value that is fixed based on the driver is applied and thus, optimum sound cannot be provided to the remaining passengers except for the driver.

### SUMMARY

The present invention provides a sound control system and method for a vehicle, wherein a sound output of a speaker is automatically adjusted based on a position in which a passenger enters the vehicle, and based on a position in which a driver enters the vehicle (depending on whether a passenger enters the vehicle) to provide an optimum sound state.

According to an aspect of the present invention, a sound control system for a vehicle that performs sound control within the vehicle may include: a passenger detecting unit installed at each vehicle seat and configured to detect a passenger in each seat including a driver; and a controller configured to detect a passenger riding position within the vehicle from a passenger detecting signal output by the passenger detecting unit and adjust sound through each speaker within the vehicle based on the passenger riding position.

According to another aspect of the present invention, a sound control method for a vehicle, wherein sound control is performed within the vehicle, may include: detecting a passenger in each seat including a driver using a passenger detecting unit installed at each seat of the vehicle; and detecting a passenger riding position within the vehicle from a passenger detecting signal output by the passenger detecting unit and adjusting sound through each speaker within the vehicle based on the passenger riding position using a controller. The passenger detecting unit may be a seat belt switch configured to detect whether a seat belt of each seat is fastened and output a corresponding signal.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an exemplary sound tuning according to the related art;

FIG. 2 illustrates an exemplary configuration of a sound control system for a vehicle according to an exemplary embodiment of the present invention;

FIG. 3 illustrates an exemplary function turned on in a setup menu to perform sound control according to an exemplary embodiment of the present invention;

FIG. 4 illustrates an exemplary configuration of a sound control system for a vehicle according to another exemplary embodiment of the present invention; and

FIGS. 5A and 5B schematically illustrate an exemplary phase control unit of each speaker according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will now be described more fully with reference to the accompanying drawings, in which exemplary embodiments of the invention are shown, so that one of ordinary skill in the art can easily embody the invention.

The present invention relates to a sound control system and method for a vehicle, configured to detect whether a passenger enters each seat within the vehicle and a sound output of a speaker may be automatically adjusted using a control value defined based on a position in which the passenger enters the seat within the vehicle to provide an optimum sound state to the passenger.

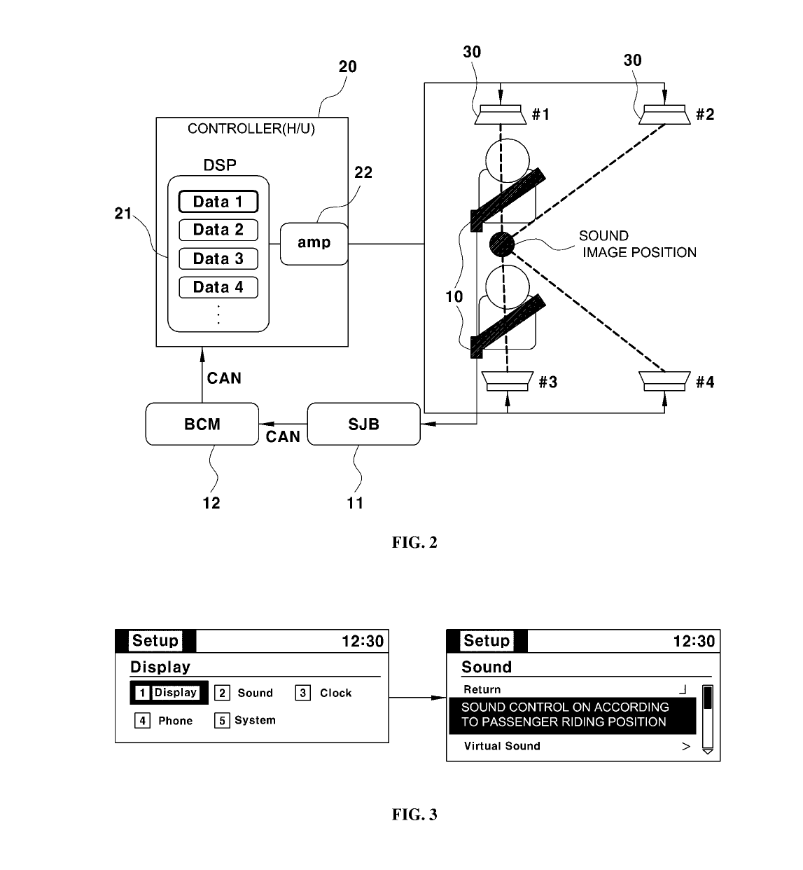

FIG. 2 illustrates an exemplary configuration of a sound control system according to an exemplary embodiment of the present invention. As illustrated in FIG. 2, the sound control system according to an exemplary embodiment of the present invention may include a passenger detecting unit 10 installed at each seat of a vehicle to adjust sound based on a position of a passenger while the vehicle is being driven and configured to detect a passenger that enters each seat including a driver, and a controller 20 configured to detect the position of the driver within the vehicle from a passenger detecting signal output by the passenger detecting unit 10 and configured to adjust sound of each of speakers 30 using a predetermined control value based on the passenger position.

In particular, the passenger detecting unit 10 may be a sensor unit configured to detect whether a passenger enter each seat within the vehicle. In other words, the sensor unit may be configured to detect when a seat within the vehicle is occupied by a person or an object. The passenger detecting signal output by the passenger detecting unit 10 of each seat may be used by the controller 20 to detect a position in which the passenger enters a seat within the vehicle including the driver (e.g., any person or object entering any seat within the vehicle), and the passenger detecting unit 10 may be a seat belt switch.

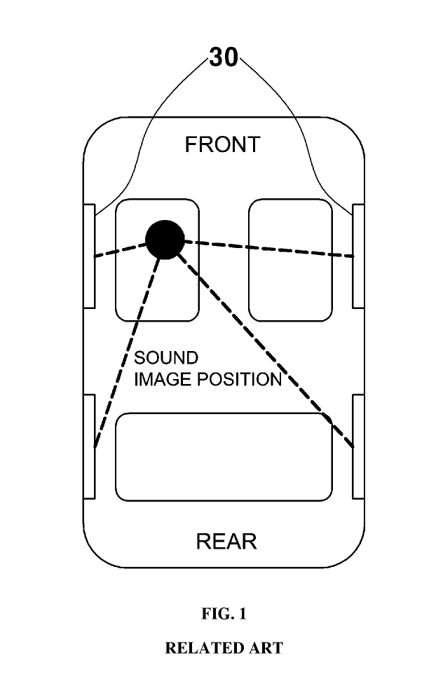

Further, a seat belt switch (e.g., buckle switch) may be a unit configured to detect whether a passenger fastens a seat belt and may be installed at each seat of a general vehicle. The seat belt switch may be a switch turned on and off based on whether a buckle is combined with a tongue of a seat belt switch. When the seat belt is fastened, a seat belt signal (e.g., seat belt-fastened signal) may be transmitted to a body control module (BCM) 12. Accordingly, the controller 20 may be configured to transmit the seat belt signal from the seat belt switch 10, transmit the seat belt signal of each seat via the BCM 12, as illustrated in FIG. 1, or transmit a predetermined signal indicative of the passenger riding position (e.g., whether the passenger sits on a seat) detected by the seat belt switch from the BCM 12. As a result, sound adjusting performed by the controller 20, in particular, sound control based on a seat belt-fastened position may be performed.

In FIG. 2, an SJB 11 represents a smart junction box. A signal output by the seat belt switch (e.g., a signal based on whether the passenger fastens the seat belt) may be transmitted to the BCM 12 via the SJB 11 using controller area network (CAN) communication. A vehicle network system may be configured within the vehicle to have a plurality of CAN domains, such as the SJB 11 and the BCM 12, transmit and receive various information via CAN communication. In the present exemplary embodiment, the controller 20 may be connected to the vehicle network system to receive a signal from the BCM 12 via CAN communication.

Thus, the signal of the seat belt switch (e.g., passenger detecting unit) 10 may be configured to be transmitted to the controller 20 on a path of the SJB 11 and the BCM 12. Further, the SJB 11 may be used based on a vehicle type, as described above. However, this is merely an example, and the signal of the seat belt switch (e.g., passenger detecting unit) 10 may be transmitted directly to the BCM 12 without the usage of the SJB 11 in a CAN communication and may also be configured to be transmitted to the controller 20 from the BCM 12. In particular, for a vehicle type to which the SJB 11 is not applied, the BCM 12 may be configured to transmit the signal of the seat belt switch 10 directly to the controller 20.

In addition, the passenger detecting unit 10 may be a well-known sensor unit that may be configured to detect whether the driver and the passenger are on the vehicle seats, and as another example of the passenger detecting unit 10 except for the seat belt switch, a piezoelectric sensor may be used as the passenger detecting unit 10. The piezoelectric sensor may be configured to output an electrical signal when the driver or passenger is in a corresponding seat. The controller 20 may be configured to receive the electrical signal to detect whether the passenger is in each seat and to recognize the passenger position within the vehicle while the vehicle is being driven (e.g., the passenger riding position). The controller 20 may be configured to adjust sound output within the vehicle using the speakers 30 based on the passenger riding position within the vehicle detected by the passenger detecting unit 10. The controller 20 may be a head unit H/U that includes a digital signal processor (DSP) 21 in an audio system or an audio, video and navigation (AVN) system.

Furthermore, the sound control system and method for the vehicle according to the present invention may operate and be performed when a user turns on a corresponding function in a setup menu of the audio system or the AVN system. FIG. 3 illustrates an example in which a function is turned on in the setup menu to perform sound control according to the present invention. When the user selects ‘sound control ON based on a passenger riding position’ in the setup menu, a sound control function according to the exemplary embodiment of the present invention may be performed. In addition, when the controller 20 is a head unit of the audio system or the AVN system, the passenger detecting signal transmitted via the BCM 12 may be transmitted to the head unit H/U via a cluster in a MM-CAN (multimedia CAN) manner. In a general vehicle network system, a gateway may be interposed between the plurality of CAN domains, such as the BCM 12, the cluster and the head unit 20, to transmit and receive a CAN message via the gateway. However, illustration of the gateway in FIG. 2 is omitted.

Moreover, to perform sound control according to the exemplary embodiment of the present invention, a sound control value for adjusting sound within the vehicle may be preset as a value according to the passenger riding position (e.g., seat belt-fastened position) and may be stored in the DSP 21 of the head unit H/U which may be the controller 20. When the passenger in each seat is detected by the passenger detecting unit 10 and a final passenger riding position is detected, the controller 20 may be configured to adjust sound within the vehicle using a corresponding control value. In particular, speaker tuning data based on the passenger riding position may be tabled and stored in the DSP 21. A predetermined sound image position within the vehicle based on the passenger riding position within the vehicle (e.g., seat belt-fastened position) and an optimum speaker output value (e.g., speaker tuning value) based on each sound image position may be stored as data for speaker tuning.

Table 1 shows an example of a speaker tuning table based on a passenger riding position within the vehicle. Table 1 shows an example in which tuning data based on a seat belt-fastened position and a sound image position are designated as ‘Data 1 to Data 24’ and may be stored. In particular, the seat belt-fastened position may be the passenger riding position within the vehicle, and the sound image position determined based on the passenger riding position within the vehicle may be stored. Furthermore, an output value of each speaker 30 (#1 to #4 of Table 4) that may provide optimum sound to an interior space of the vehicle may be designated in each sound image position.

An optimum output value of each speaker (#1 to #4) based on each sound image position may be a value determined by a test in a process of developing the vehicle. In addition, an optimum output value based on speaker with respect to each sound image position based on the vehicle type may be determined by a test and may be stored as data (e.g., tuning may be performed based on the vehicle type).

TABLE 1

| Tuning | Seat belt-fastened | Sound image | Speakers (#1 to #4) |
|---|---|---|---|
| data | position | position | Output value (W) |
| Data 1 | Driver's seat | Driver's seat | #1 = A1, #2 = B1, |
| | | | #3 = C1, #4 = D1 |
| Data 2 | Front passenger seat | Front passenger | #1 = A2, #2 = B2, |
| | | seat | #3 = C2, #4 = D2 |
| Data 3 | Left rear seat | Left rear seat | #1 = A3, #2 = B3, |
| | | | #3 = C3, #4 = D3 |
| Data 4 | Right rear seat | Right rear seat | #1 = A4, #2 = B4, |
| | | | #3 = C4, #4 = D4 |
| Data 5 | Driver's seat + front | In the middle of | #1 = A5, #2 = B5, |
| | passenger seat | driver's seat and | #3 = C5, #4 = D5 |
| | | front passenger | |
| | | seat | |
| Data . . . | . . . | . . . | . . . |
| Data 24 | Driver's seat + front | In center of | #1 = A24, |
| | passenger seat + left | vehicle | #2 = B24, |
| | rear seat + right | | #3 = C24, #4 = D24 |
| | rear seat | | |

* A, B, C, and D are output values that are determined according to the speakers.

Table 1 shows an example of a tuning table that may be applied to the exemplary embodiment. Since the fixed number of passengers (e.g., the number of seats) may vary according to a vehicle type, an appropriate tuning table should be applied based on the vehicle type and the fixed number of passengers. For example, since there is a difference in the fixed number of passengers, such as a five-seater (e.g., five passenger vehicle) vehicle or a seven-seater (e.g., seven passenger vehicle) vehicle, based on the vehicle type, a tuning table in which sound image adjustment for five persons may be performed for a five-seater vehicle, should be preset, and a tuning table in which sound image adjustment for seven persons may be performed for a seven-seater vehicle, should be preset.

Since various combinations of seat belt-fastened positions may be manufactured based on the vehicle type and the fixed number of passengers, the number of tuning data may vary from Table 1, and exemplary embodiments of the present invention are not limited to the example of Table 1. Referring to Table 1, outputs of the speakers 30 (#1 to #4) may be controlled and when the driver is detected in the seat, a sound image position may be selected as a driver's seat, A, B, C, and D may be selected as target output values for adjusting the speakers #1 to #4 in which the driver's seat may be set as the sound image position and sound output in each speaker may be performed using a corresponding output value.

In particular, an optimum output value of each speaker 30 (#1 to #4) based on a seat belt-fastened position and a sound image position may be previously designated as tuning data, and the controller 20 may be configured to adjust outputs of the speakers 30 (#1 to #4) using the optimum value based on the seat belt-fastened position and the sound image position detected by the passenger detecting unit 10. Further, in the configuration of FIG. 2, the central processing unit (CPU 21a) may be configured to determine a passenger's riding position based on the seat belt-fastened position by receiving the signal of the seat belt switch 10 and transmit control data that matches the passenger's riding position of the tuning table of the DSP 21 to the DSP 21. Thus, the DSP 21 may be configured to transmit an output value of each speaker 30 tuned based on each speaker 30 by referring to the tuning table stored in the DSP 21 according to a control signal of the CPU 21a, to an amplifier 22 and output the output value from each speaker 30. As a result, when an output of each speaker within the vehicle is adjusted based on the sound image position selected based on a position in which the passenger enters the seat, optimum sound in which a single passenger or a plurality of passengers may satisfy equally, may be provided.

When a change occurs in the passenger entering in the vehicle, i.e., when a new passenger enters the vehicle or when an existing passenger exits the vehicle, the controller 20 may be configured to select new tuning data (e.g., each speaker output control value) based on the changed passenger riding position detected by the passenger detecting unit 10 and adjust an output of each speaker 30 using an output value set according to the tuning data. As a result, optimum sound control within the vehicle may be performed based on the passenger riding position.

In another exemplary embodiment of the present invention, a control value for adjusting a phase of each speaker 30 based on the passenger riding position, i.e., optimum speaker phase value data may be tabled and stored in a memory of the controller 20, for example, in the CPU 21a of the head unit H/U. A predetermined sound image position within the vehicle based on the passenger riding position (e.g., seat belt-fastened position) and an optimum speaker phase value based on each sound image position may be stored as data to be stored. FIG. 4 illustrates an exemplary configuration of a sound control system for a vehicle according to another exemplary embodiment of the present invention, and Table 2 shows an example of a speaker phase value table based on a passenger riding position within the vehicle. Table 2 shows an example in which optimum phase value data of each speaker 30 (#1 to #4) based on a seat belt-fastened position and a sound image position are designated as ‘Data 1 to Data 24’ and may be stored.

In particular, the seat belt-fastened position may be the passenger riding position within the vehicle, and the sound image position determined based on the passenger riding position within the vehicle may be stored. Furthermore, phase value data of each speaker 30 (#1 to #4 of Table 4) that may provide optimum sound to an interior space of the vehicle may be designated in each sound image position. Optimum phase value data of each speaker (#1 to #4) based on each sound image position may be a value determined by a test while manufacturing the vehicle, and an optimum phase value based on speaker with respect to each sound image position according to the vehicle type may be determined by a test and may be stored as data (e.g., tuning may be performed according to the vehicle type).

TABLE 2

| Speaker | | Sound image | Speakers (#1 to #4) |
|---|---|---|---|
| phase data | Seat belt-fastened position | position | Phase value (°) |
| Data 1 | Driver's seat | Driver's seat | #1 = A, #2 = B, #3 = C, |
| | | | #4 = D |
| Data 2 | Front passenger seat | Front passenger seat | #1 = A1, #2 = B1, |
| | | | #3 = C1, #4 = D1 |
| Data 3 | Left rear seat | Left rear seat | #1 = A2, #2 = B2, |
| | | | #3 = C2, #4 = D2 |
| Data 4 | Right rear seat | Right rear seat | #1 = A3, #2 = B3, |
| | | | #3 = C3, #4 = D3 |
| Data 5 | Driver's seat + front passenger | In the middle of | #1 = A4, #2 = B4, |
| | seat | driver's seat and front | #3 = C4, #4 = D4 |
| | | passenger seat | |
| Data . . . | . . . | . . . | |
| Data 24 | Driver's seat + front passenger | In center of vehicle | #1 = A24, #2 = B24, |
| | seat + left rear seat + right rear | | #3 = C24, #4 = D24 |
| | seat | | |

* A, B, C, and D are phase values that are determined according to the speakers.

Table 2 shows an example of a tuning table that may be applied to another exemplary embodiment. Since the fixed number of passengers (e.g., the number of seats) may vary based on a vehicle type, an appropriate tuning table should be applied based on the vehicle type and the fixed number of passengers. For example, since there may be a difference in the fixed number of passengers, such as a five-seater (five passenger vehicle) vehicle or a seven-seater (e.g., seven passenger vehicle) vehicle, based on the vehicle type, a tuning table in which sound image adjustment for five persons may be performed for a five-seater vehicle, should be preset, and a tuning table in which sound image adjustment for seven persons may be performed for a seven-seater vehicle, should be preset. Since various combinations of seat belt-fastened positions may be used based on the vehicle type and the fixed number of passengers, the number of tuning data may vary from Table 2, and exemplary embodiments of the present invention are not limited to the example of Table 2.

Referring to Table 2, outputs of the speakers 30 (#1 to #4) may be adjusted and when the driver is in the seat, a sound image position may be selected as a driver's seat, A, B, C, and D may be selected as target phase values for adjusting the speakers #1 to #4 in which the driver's seat is set as the sound image position and sound output in each speaker may be performed using a corresponding phase value. Therefore, an optimum phase value of each speaker 30 (#1 to #4) based on a seat belt-fastened position and a sound image position may be previously designated as tuning data, and the controller 20 may be configured to adjust speaker phase control in which a phase value may be selected based on the seat belt-fastened position and the sound image position detected by the passenger detecting unit 10 and the phase value may be used as a control value. As a result, when a phase of each speaker within the vehicle is adjusted based on the sound image position selected based on a position in which the passenger enters the seat within the vehicle, optimum sound in which a single passenger or a plurality of passengers may satisfy equally, may be provided.

When a change in the passenger who enters the vehicle occurs, that is, when a new passenger enters the vehicle or when an existing passenger exits the vehicle, the controller 20 may be configured to select a new phase value (e.g., speaker phase control value) of each speaker 30 based on the changed passenger riding position detected by the passenger detecting unit 10 and adjust a phase of each speaker 30 using a phase value set according to the phase value. As a result, optimum sound control within the vehicle may be performed based on the passenger riding position.

In the above-described exemplary embodiment, speaker phase control may be performed and when each speaker 30 includes a phase control unit (e.g., a phase controller) and the controller 20 outputs a control signal to adjust the phase of each speaker using an optimum control value to each speaker 30, a phase control unit of each speaker 30 may be operated based on the control signal and the phase of a corresponding speaker 30 may be adjusted. Further, speaker phase control may be adjusting a sound output direction of the speaker 30. In particular, the sound output direction of the speaker 30 may be adjusted using a method of adjusting an angle of each speaker 30 within the vehicle or a method of adjusting an angle of a reflector 37 through which sound may be reflected, by installing the reflector 37 at a front side of the speaker 30.

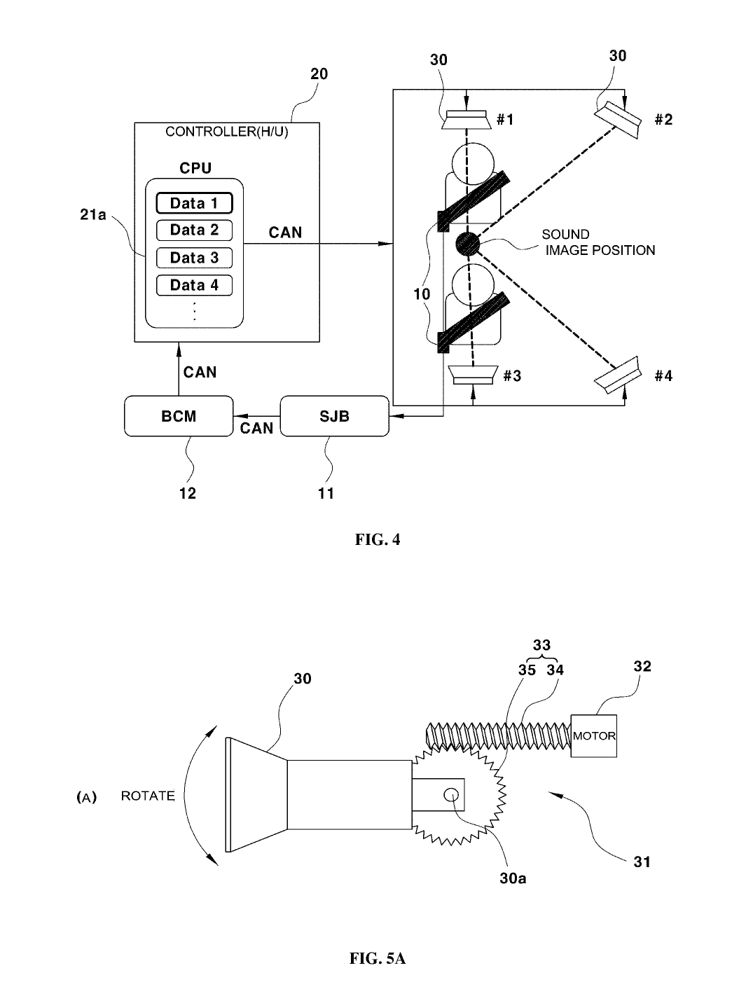

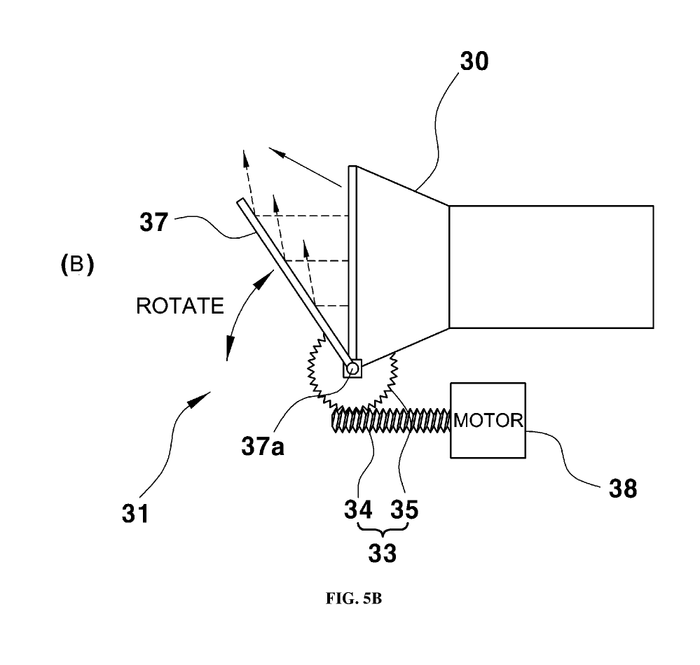

FIGS. 5A and 5B schematically illustrate an exemplary phase control unit 31 of each speaker 30 according to another exemplary embodiment of the present invention. FIG. 5A illustrates an exemplary configuration of the phase control unit 31 configured to adjust an angle of the speaker 30, and FIG. 5B illustrates an exemplary configuration of the phase control unit 31 configured to adjust a sound output direction using the reflector 37.

As illustrated in FIG. 5A, as an example of the phase control unit 31, a configuration in which the speaker 30 that may be rotated about a rotation shaft 30a to adjust an angle of the speaker 30, may be mounted on the vehicle and rotation of the speaker 30 may be performed by a driving force of an electric motor 32, may be used. In particular, a gear device 33 may be interposed between a driving shaft of the electric motor 32 driven and operated based on a control signal of the controller (see 20 of FIG. 4) and the rotation shaft 30. Thus, the driving force of the electric motor 32 may be transmitted to the rotation shaft 30a of the speaker 30 by the gear device 33. In this configuration, an angle of the speaker 30 rotated by a rotational force generated when driving of the electric motor 32 is adjusted based on the control signal of the controller 20, may be adjusted.

FIGS. 5A and 5B illustrate an exemplary configuration in which a worm 34 of an electric motor driving shaft and a worm wheel 35 of a speaker rotation shaft may be combined with the gear device 33. However, a configuration in which the rotational force of the electric motor 32 driven and operated based on the control signal of the controller 20 may be decelerated and may be transmitted to the rotation shaft 30a of the speaker 30, may be used.

Alternatively, as illustrated in FIG. 5B, as another example of the phase control unit 31, a configuration in which a reflector 37 through which sound may be reflected in a certain direction may be rotatably installed at a front side of each speaker 30 and an angle of the reflector 37 may be adjusted by a driving force of an electric motor 38 adjusted based a control signal of the controller 20, may be used. In particular, a gear device 33 may be interposed between a driving shaft of the electric motor 38 driven and operated based on the control signal of the controller (see 20 of FIG. 4) and a rotation shaft 37a of the reflector 37. Thus, the driving force of the electric motor 38 may be transmitted to the rotation shaft 37a of the reflector 37 through the gear device 33. In this configuration, an angle of the reflector 37 rotated by a rotational force generated when driving of the electric motor 38 is adjusted based on the control signal of the controller 20, may be adjusted. Accordingly, the angle of the reflector 37 may be adjusted to adjust a transmission direction of sound output to the front side of the speaker 30, and when this configuration is installed at each speaker 30, similar to the phase control method of FIG. 5A wherein an angle of the speaker 30 may be directly changed and adjusted, the effect of adjusting the phase of the speaker 30 based on the control signal (e.g., electrical signal) of the controller 20 may be achieved.

As described above, in a sound control system and method for a vehicle according to an exemplary embodiment of the present invention, a sound output of a speaker may be automatically adjusted based on a position in which a passenger enters a seat within the vehicle, including a driver (e.g., depending on whether a passenger is in a seat) to provide optimum (e.g., improved) sound to the driver and the passenger.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A sound control system for a vehicle that performs sound control within the vehicle, comprising:
a passenger detecting unit installed at each seat of the vehicle and configured to detect a passenger in each seat; and
a controller configured to detect a passenger riding position within the vehicle from a passenger detecting signal output by the passenger detecting unit and adjust sound through each speaker within the vehicle based on the passenger riding position.

2. The sound control system of claim 1, wherein the passenger detecting unit is a seat belt switch configured to detect whether a seat belt of each seat is fastened and configured to output a corresponding signal.

3. The sound control system of claim 1, wherein:
a sound image position within the vehicle based on the passenger riding position and an optimum speaker output value based on each sound image position are stored in the controller,
the controller is configured to detect the passenger riding position to adjust an output of each speaker using the stored optimum speaker output value.

4. The sound control system of claim 1, wherein:
a sound image position within the vehicle based on the passenger riding position and an optimum speaker phase value based on each sound image position are stored in the controller, and
a phase controller is disposed at each speaker within the vehicle, and
the controller is configured to detect the passenger riding position to adjust operation of the phase controller to adjust a phase of each speaker using the stored optimum speaker phase value.

5. The sound control system of claim 4, wherein the phase control unit is configured to adjust an angle of each speaker to adjust a sound output direction of each speaker and includes an electric motor combined with each speaker to provide a rotational force to rotate each speaker about a rotation shaft.

6. The sound control system of claim 4, wherein the phase control unit is configured to adjust a sound output direction of each speaker and includes:
a reflector rotatably installed at a front side of each speaker and through which sound output from each speaker is reflected in an adjusted direction based on a rotated angle; and
an electric motor driven based on a control signal of the controller and combined with the reflector to provide a rotational force to adjust an angle of the reflector.

7. A sound control method for a vehicle, comprising:
detecting, by a sensor, a passenger that enters a seat of the vehicle using a passenger detecting unit installed at each seat of the vehicle;
detecting, by a controller, a passenger riding position within the vehicle from a passenger detecting signal output by the passenger detecting unit; and
adjusting, by the controller, sound through each speaker within the vehicle based on the passenger riding position.

8. The sound control method of claim 7, wherein the passenger detecting unit is a seat belt switch configured to detect whether a seat belt of each seat is fastened and output a corresponding signal.

9. The sound control method of claim 7, further comprising:
storing, by the controller, a sound image position within the vehicle based on the passenger riding position and an optimum speaker output value based on each sound image position; and
detecting, by the controller, the passenger riding position to adjust an output of each speaker using the stored optimum speaker output value.

10. The sound control method of claim 7, further comprising:
storing, by the controller, a sound image position within the vehicle based on the passenger riding position and an optimum speaker phase value based on each sound image position; and
detecting, by the controller, the passenger riding position to adjust driving of a phase control unit disposed at each speaker to adjust a phase of each speaker using the stored optimum speaker phase value.
